(19) United States
(12) Patent Application Publication
(10) Pub. No.: US 2024/0119629 A1
(43) Pub. Date: Apr. 11, 2024

(54) SENSOR TIMING CORRELATION

(71) Applicant: Alarm.com Incorporated, Tysons, VA (US)

(72) Inventors: Aditya Shiwaji Rasam, McLean, VA (US); Ahmad Seyfi, Reston, VA (US); Timon Meyer, Centreville, VA (US); Donald Gerard Madden, Columbia, MD (US); Glenn Tournier, Vienna, VA (US)

(21) Appl. No.: 18/373,772

(22) Filed: Sep. 27, 2023

Related U.S. Application Data
(60) Provisional application No. 63/414,254, filed on Oct. 7, 2022.

(51) Int. Cl. G06T 7/80; G06T 7/50; G06T 7/73

(52) U.S. Cl. CPC G06T 7/80; G06T 7/50; G06T 7/73; G06T 2207/10048; G06T 2207/30204

(57) ABSTRACT

Methods, systems, and apparatus, including computer programs encoded on computer storage media, for sensor timing correlation. One of the methods includes obtaining (i) first sensor data from a first sensor and (ii) second sensor data from a second sensor; detecting a representation of an object in both the first sensor data and the second sensor data; determining a predicted physical distance between a first representation of the object in the first sensor data and a second representation of the object in the second sensor data; determining a timing offset between the different sensors using the predicted physical distance between the first representation of the object and the second representation of the object; and adjusting, using the timing offset, subsequent data from the first sensor or the second sensor.

### CROSS-REFERENCE TO RELATED APPLICATION

This application claims the benefit of U.S. Provisional Application No. 63/414,254, filed Oct. 7, 2022, the contents of which are incorporated by reference herein.

### BACKGROUND

A monitoring system for a property can include various components including sensors, e.g., cameras, and other devices. For example, the monitoring system may use the camera to capture images of people or objects of the property. Sometimes a monitoring system can use a drone to capture sensor data.

### SUMMARY

This specification describes techniques, methods, systems, and other mechanisms for correlating data from two or more sensors, e.g., included in a single device. A sensor of the two or more sensors can include a sensor that is not able to detect visual light (e.g., infrared, time of flight (ToF), among others). Sensors may be affixed on a robot. As the robot moves within a space, or when stationary, the sensors can provide information of the space and aid the robot in navigation or other actions. Because of delays within sensing elements or processing, an apparent time that sensor data is received may not reflect an actual time that a sensed event occurs. By detecting an offset synchronization object using two or more sensors, sensor delays can be effectively measured and compensated for.

Robots can be configured with an array of multiple sensors like light detection and ranging (LIDAR), cameras, a Time of Flight sensor, an Inertial Measurement Unit (IMU), among others. In some cases, these sensors leverage their own system on a module (SOM) with their own firmware which may not include time stamping. One approach is to assign a timestamp when sensor information is queried from a higher level system at the time of arrival. This specification describes a more precise time stamp assignment to correct for potential latency that can occur when obtaining sensor data (e.g., from sensor, SOM, among others) or processing sensor data.

One challenge in correlating sensor data from multiple sensors is that two or more sensors may not be able to detect a same object. For example, a red green blue (RGB) camera can detect a digital clock. Synchronizing two RGB cameras can include simply capturing footage of a digital clock and adjusting time stamps such that data from the two cameras corresponding to the same change in the digital clock have the same time stamp. However, in other cases (e.g., an RGB camera and a depth sensor, such as ToF), sensors may not be able to detect a same object. This specification describes the use of an offset synchronization object to help measure a time shift between two or more sensor data-streams. The offset synchronization object can change a visual appearance or move in a way that is detectable by the two or more sensors. Using the detection of the offset synchronization object in data streams of the two or more sensors, a computing device can determine a timestamp adjustment and apply an offset to one or more data streams to synchronize data from the two or more sensors.

In general, one innovative aspect of the subject matter described in this specification can be embodied in methods that include the actions of obtaining (i) first sensor data from a first sensor and (ii) second sensor data from a second sensor; detecting a representation of an object in both the first sensor data and the second sensor data; determining a predicted physical distance between a first representation of the object in the first sensor data and a second representation of the object in the second sensor data; determining a timing offset between the different sensors using the predicted physical distance between the first representation of the object and the second representation of the object; and adjusting, using the timing offset, subsequent data from the first sensor or the second sensor.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, detecting the representation of the object in both the first sensor data and the second sensor data includes: detecting a rotating object with at least one first feature detectable by the first sensor and at least one second feature detectable by the second sensor. In some implementations, the first sensor is an infrared camera and the at least one first feature includes an infrared marker; and the second sensor is a depth sensor that captures depth data of the rotation of the object. In some implementations, determining the distance between the first representation of the object in the first sensor data and the second representation of the object in the second sensor data includes: determining an angular distance between (i) a first line indicating a position of the object in the first sensor data and (ii) a second line indicating a position of the object in the second sensor data.

In some implementations, prior to determining the timing offset between the different sensors using the distance between the first representation of the object and the second representation of the object, actions include: determining a velocity of the object using the first sensor data and the second sensor data; and subsequent to determining the velocity, determining the timing offset using the velocity.

In some implementations, actions include using the subsequent data from the first sensor or the second sensor to perform one or more of the following: navigation, localization, or environmental adjustments.

In some implementations, determining the timing offset includes: providing the distance between the first representation of the object in the first sensor data and the second representation of the object in the second sensor data to a proportional-integral-derivative (PID) controller configured to generate output for use adjusting the subsequent data using the timing offset. In some implementations, actions include: determining that the predicted physical distance between the first representation of the object and the second representation of the object satisfies a difference threshold; and in response to determining that the predicted physical distance satisfies the difference threshold, adjusting, using the PID controller and the timing offset, timestamps of the subsequent data from the first sensor or the second sensor to reduce, compared to a first error for the predicted physical distance, a second error for a distance between representations of a second object in the subsequent data.

In some implementations, actions include: performing processing operations that simulate a processing load, where the processing affects processing of the first sensor data or the second sensor data.

In some implementations, actions include: detecting, from a plurality of processes that the system can perform and that can cause a first change for processing data from the first sensor or a second change for processing data from the second sensor, a process performed by the system at least partially concurrently with processing of the subsequent data from the first sensor or the second sensor and that will cause the first change for processing data from the first sensor to be a different change than the second change for processing data from the second sensor; and adjusting the timing offset used to adjust the subsequent data using a difference between the first change and the second change. In some implementations, where one of the first change or the second change for processing data indicates no change.

In some implementations, actions include: providing current processing bandwidth to a model configured to determine a timing offset using the current processing bandwidth; and determining the timing offset using output from the model.

In some implementations, actions include: in response to determining a change in processing firmware or hardware, obtaining (i) the first sensor data from the first sensor and (ii) the second sensor data from the second sensor.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. For example, generating and comparing a detection of an offset synchronization object by sensors can allow sensors with different sensing abilities to be correlated in time to determine a relative or absolute time offset. The timing offset can be used to correct time stamp information of sensor data obtained by one or more sensors when the time stamp information is incorrect, does not align with timing information of another sensor, or both. Corrected sensor data can be used in navigation or other actions performed by a robot, such as environment manipulation, surveillance, among others, e.g., enabling more accurate navigation, other actions, or both.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an example of a system for sensor timing correlation.

FIG. 2 is a flow diagram illustrating an example of a process for sensor timing correlation.

FIG. 3 is a diagram illustrating an example of a property monitoring system.

Like reference numbers and designations in the various drawings indicate like elements.

### DETAILED DESCRIPTION

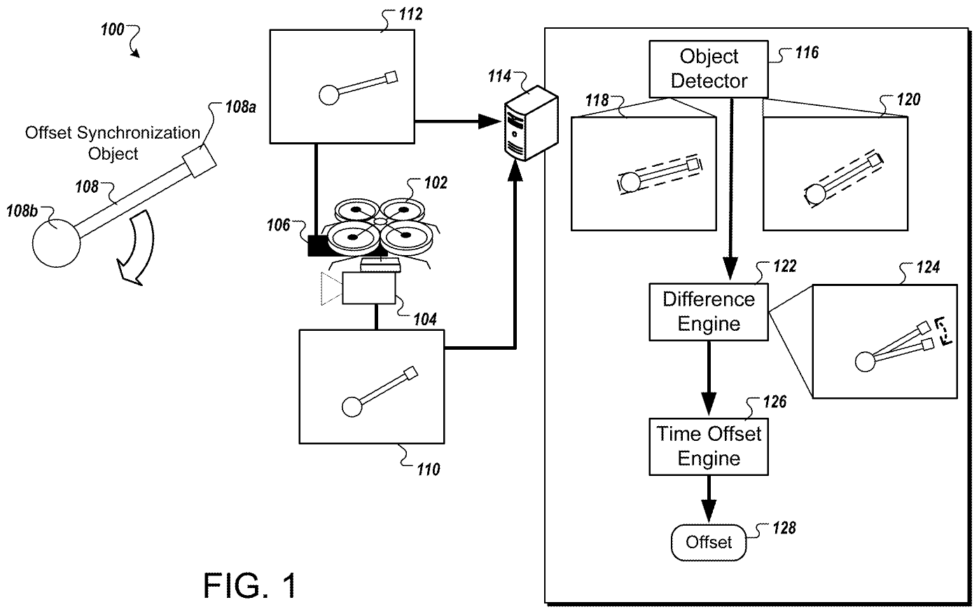

FIG. 1 is a diagram showing an example of an environment for sensor timing correlation. The environment includes the system 100 that includes a robot 102 affixed with sensors 104 and 106 and a control unit 114. The environment includes an offset synchronization object 108. The offset synchronization object 108 can be communicably connected to the robot 102 or the control unit 114 and can be used to synchronize sensor data from different sensors included in the robot 102.

For autonomous drone navigation with RGB-D simultaneous localization and mapping (SLAM), accurate registration of RGB and Depth is important. Registration should hold for static as well as dynamic conditions. For dynamic registration, time synchronization of two corresponding data frames of RGB and Depth (e.g., ToF) can be especially important. For accurate time synchronization, it can be important to know a time offset between an RGB frame capture and ToF frame capture at a same time instant (e.g., the sensor data 110 and 112). Even though the frames from two sensors were subscribed at the same time instant, each one of them can have intrinsic processing delays from the moment the event was captured to the moment it was processed, assigned a time-stamp and made available to the system. The time offset can also occur from incorrect time-stamping.

It is useful, especially in the robot context for various tasks (e.g., navigation, surveillance, among others), to determine a time offset between a same physical event captured by an RGB and ToF frame. For multi-camera time offset computation, an LED based counter (8 LED for 8-bit counter) can be used where an LED combination is captured by each camera. Knowing a frequency of the counter, the time offset between two cameras can be computed. For ToF camera, however, which can be infrared based, detecting a LED with visible light spectrum can be difficult if not impossible. So for ToF to RGB registration an alternative technique can be used, as discussed, where a physical event is created by moving an object detectable by both sensors (e.g., rotating a stepper motor at known angular speed and attaching an arm with an infrared marker on it which was detected by both RGB and ToF camera).

In some implementations, a setup for capturing the offset synchronization object 108 can include two sensors substantially center aligned horizontally and in the same plane like a stereo pair, such that the angular offset of the image plane of both sensors satisfies a threshold (e.g., has little to no angular offset). The robot 102 or the offset synchronization object 108 can be moved such that the offset synchronization object 108 is where lens distortion effect is lowest (e.g., at the center of an image captured by the sensors). The offset synchronization object 108 can be kept moving (e.g., rotating) at a known speed or direction. In some implementations, sensor data pairs are captured based on closest time-stamps and then rectified. For example, the control unit 114 can compare timestamps from sensor data provided by the first sensor 104 and the second sensor 106 and select the sensor data 110 and 112 as a pair that, from the two data streams, have the closest time stamps. The control unit 114 can then determine the offset 128 using this pair. In some implementations, the control unit 114 determines multiple offsets from multiple pairs of sensor data. For example, the control unit 114 can determine multiple offsets and perform an average or weighted average on the multiple offsets to determine the offset 128.

Based on an event captured by two frames (e.g., movement of the offset synchronization object 108), the control unit 114 can use computer vision algorithms to detect a point (e.g., a center) of the offset synchronization object 108. In some implementations, the control unit 114 detects a marker on the offset synchronization object 108 and determines a line between them in each of the pair of sensor data (e.g., RGB data and infrared (IR) image. The control unit 114 can project a line from one sensor data (e.g., IR) to another (e.g., RGB data) knowing extrinsic information of the two sensors. The control unit 114 can determine a difference between the representations of the offset synchronization object 108 in each sensor data (e.g., an angle of difference between the determined lines). Using the angle and a known speed or movement of the offset synchronization object 108, the control unit 114 can compute the time offset 128.

In some implementations, a line projected by the control unit 114 using sensor data is projected from a ToF frame to an RGB frame. For example, a line detected by a ToF sensor can have depth information about two or more points (e.g., the shaft 108b, or central point of the offset synchronization object 108, and the element 108a). Three dimensional coordinates can be projected from a given frame captured by a given ToF sensor to an RGB frame, e.g., captured by a visual camera, using extrinsic information. Three dimensional coordinates of the two or more points in the RGB frame can be projected, e.g., by the control unit 114, in the RGB image plane using intrinsic information of RGB to form a new line in RGB as seen by a ToF sensor.

In some implementations, the robot 102 is affixed with the control unit 114 as an onboard processing device. In some implementations, the robot 102 can be a separate device from the control unit 114. In some implementations, the robot 102 is an aerial drone.

The robot 102 can include any appropriate sensors. Sensors that provide data for processing by the system 100 can include one or more of a LIDAR sensor, camera, Time of Flight sensor, IMU, among others.

The first sensor 104 obtains sensor data 110 and the second sensor 106 obtains sensor data 112. Both the sensor data 110 and sensor data 110 represent a detection of the offset synchronization object 108. Representations of the sensor data can be dependent on the particular sensor that obtained the data. For example, the first sensor 104 can be visual camera that obtains an image of the offset synchronization object 108. The second sensor 106 can be a depth sensor that obtains a representation of the offset synchronization object 108 using infrared light.

In the example of FIG. 1, the offset synchronization object 108 is a moving object with an element 108a detectable by one or more of the sensors 104 and 106. In some implementations, the element 108a is an infrared marker. In some implementations, the offset synchronization object 108 is affixed with a motor to rotate the element 108a at a known speed. In some implementations, the offset synchronization object 108 rotates. In some implementations, the offset synchronization object 108 moves linearly. In some implementations, the offset synchronization object 108 changes appearance without moving and the appearance change is detectable by the sensors 104 and 106.

In some implementations, the first sensor 104 and the second sensor 106 are in the same plane. For example, the first sensor 104 and the second sensor 106 can be in a horizontal plane, e.g., approximately parallel with a ground surface. The first sensor 104 and the second sensor 106 can be in a vertical plane, e.g., approximately perpendicular to a ground surface. In general, the robot 102 can move using propellers, tires, motors, manual human assistance, among other means of locomotion to obtain sensor data of the offset synchronization object 108.

The control unit 114 obtains sensor data from the sensors 104 and 106. The robot 102, or any of the sensors 104 and 106, can provide sensor data to the control unit 114. In some examples, the control unit 114 is part of the robot 102.

The control unit 114 can operate or communicate with one or more devices configured to operate an object detector 116, difference engine 122, and time offset engine 126. A given device can operate as a given engine or detector by performing one or more actions discussed in regard to the given engine or detector.

The object detector 116 obtains the sensor data 110 and 112 and detects the offset synchronization object 108. A graphical representation of an object detection generated by the object detector 116 is shown in items 118 and 120. In some implementations, the object detections of the object detector 116 are rectangular. In some implementations, the object detections of the object detector 116 are spherical, another appropriate shape, represent a detected outline of an object, or a combination of features.

The object detector 116 provides detected object data to the difference engine 122. The difference engine 122 obtains the detected object data. The detected object data can include one or more values indicating the detected offset synchronization object 108 in the sensor data 110 and 112. The detected object data can indicate a region of a two-dimensional representation of the sensor data 110 and 112 that includes the offset synchronization object 108.

In some implementations, the object detector 116 detects a center of motion (e.g., motor shaft 108b) and the element 108a. In some implementations, the difference engine 122 determines a line between one or more objects detected by the object detector 116. For example, the difference engine 122 can determine a line between the motor shaft 108b that rotates the offset synchronization object 108 and the element 108a. The difference engine 122 can determine a line using the sensor data 110 and a line using the sensor data 112.

The difference engine 122 determines a difference between the representation of the offset synchronization object 108 in the sensor data 110 and the representation of the offset synchronization object 108 in the sensor data 112. In some implementations, the difference engine 122 uses two or more determined lines to determine a difference between sensor data. For example, the difference engine 122 can determine a line in the sensor data 110 using a detected center of motion (e.g., the motor shaft 108b) and a point that is rotating (e.g., the element 108a) as they are represented in the sensor data 110. Similarly, the difference engine 122 can determine a line in the sensor data 112 using a detected center of motion (e.g., the motor shaft 108b) and a point that is rotating (e.g., the element 108a) as they are represented in the sensor data 112. The difference engine 122 can determine an angle that separates a line determined from the sensor data 110 and a line determined from the sensor data 112.

In some implementations, the difference engine 122 uses extrinsic information to compare the two representations of the offset synchronization object 108. For example, the difference engine 122 can obtain information indicating a physical separation between the first sensor 104 and the second sensor 106. If the first sensor 104 and the second sensor 106 are affixed to the robot 102, the information can include one or more values indicating a distance between the first sensor 104 and the second sensor 106, information about elevation changes, angles of view, distortions by the sensors, among others, or a combination of these. In some implementations, the difference engine 122 obtains extrinsic information for one or both sensors 104, 106 from the robot 102 or the sensors 104 and 106. In some implementations, the robot 102 or the sensors 104 and 106 provide extrinsic information to the difference engine 122.

In some implementations, the difference engine 122 uses extrinsic information to determine a common point of comparison for one or more determined lines. For example, the difference engine 122 can determine a common point for a base of the line determined from the sensor data 110 and the line determined from the sensor data 112. After determining a common point, the difference engine 122 can determine a difference in the representation of the offset synchronization object 108 in the sensor data 110 and the sensor data 112 (e.g., the position of the element 108a as represented in the sensor data 110 and the sensor data 112).

In some implementations, extrinsic information affects a determined difference between representations of an object. For example, if extrinsic information indicates that the first sensor 104 is above the second sensor 106 in regard to a ground surface, the first sensor 104 may indicate a smaller angle than the second sensor 106 (e.g., if above the plane perpendicular to an axis of rotation of the offset synchronization object 108 and parallel to a ground surface). A graphical representation of a difference between the representations of the offset synchronization object 108 in both the sensor data 110 and 112 is shown in item 124.

The difference engine 122 provides one or more values indicating a difference between the representations of the offset synchronization object 108 in the sensor data 110 and 112 to the time offset engine 126. For example, the difference engine 122 can provide a degree value indicating an angle of separation between a line determined from the sensor data 110 and a line determined from the sensor data 112. In some implementations, the difference engine 122 provides a value indicating a difference in linear movement. For example, the offset synchronization object 108 can move linearly and the difference engine 122 can determine a distance between representations of the offset synchronization object 108 in the sensor data 110 and the sensor data 112. In some implementations, the difference engine 122 provides a value indicating a difference in appearance. For example, the offset synchronization object 108 can change an appearance that is detectable by the two or more sensors (e.g., sensor 104 and 106) and the difference engine 122 can determine one or more difference values that indicate a difference in this change of appearance as represented in the sensor data 110 and sensor data 112.

The time offset engine 126 generates an offset 128. The offset 128 can indicate that either the first sensor 104 or the second sensor 106 suffers a processing or detection delay more than the other. The offset can be applied by the control unit 114 to subsequent data obtained from one or both of the sensors to synchronize the data obtained from the sensors.

The process described in regard to FIG. 1 can be repeated after the control unit 114 detects a system update or other change to processing of data from the sensors 104 or 106. Changes to processing, such as new hardware or a new software process, can affect a processing delay and can affect the accuracy of a synchronization offset generated by the control unit 114.

In some implementations, the time offset engine 126 generates the offset 128 using one or more difference values generated by the difference engine 122. For example, the time offset engine 126 can obtain one or more values from the difference engine 122 indicating an angle between determined lines as discussed. The time offset engine 126 can generate the offset 128 as the result of the angle determined by the difference engine 122 divided by a known angular speed of the offset synchronization object 108. In some implementations, the time offset engine 126 obtains an angular speed of the offset synchronization object 108 from a transmitter of the offset synchronization object 108. In some implementations, the time offset engine 126 generates and provides a control signal to the offset synchronization object 108 that controls the offset synchronization object 108 to move at a particular speed (e.g., a particular angular speed) or in a particular manner (e.g., linear movement).

In some implementations, the control unit 114 uses a feedback loop to adjust one or more timestamps of sensor data. For example, the control unit 114 can determine a difference between the offset synchronization object 108 in item 118 and item 120. The control unit 114 can then, using the offset 128 determine a timing offset to apply to one or more sensors that obtain data for items 118 and 120. In some implementations, the control unit 114 can vary timestamp offsets over a range and determine in which direction applying an offset causes the offset synchronization object 108 in multiple obtained sensor data to overlap.

In some implementations, the control unit 114 uses a controller, such as a proportional-integral-derivative controller (PID controller). For example, the control unit 114 can use a PID controller to determine an adjustment in timestamps and a direction of change, e.g., increment or decrement, to reduce an angle or linear offset in items 118 and 120. The control unit 114 can determine an adjustment by controlling the timestamping of one or more sensor systems (e.g., timestamping of frames captured by a camera, timestamping of frames captured by a ToF sensor, among others).

In some implementations, the control unit 114 access a camera manager to adjust a time offset for timestamping. For example, the control unit 114 can transmit an instruction to a camera manager of the first sensor 104. The camera manager can control the timestamp value added to frames obtained by the first sensor 104. The control unit 114 can determine offsets to adjust timestamps of the first sensor 104, or other sensors, using the offset 128. In some implementations, the control unit 114 uses output from a PID controller. In some implementations, the control unit 114 provides the offset 128 to a PID controller to determine a timing offset for one or more sensor data streams.

In some implementations, instead of using the offset synchronization object 108, the control unit 114 obtains sensor data of a physical event observed at a property. For example, sensors 104 and 106 can observe any physical event, e.g., a door frame moving based on a moving frame of reference of the robot 102, a human moving, an animal moving, a car moving, among others. The control unit 114 can use a feedback loop to adjust timestamps of one or more sensor data streams until a measured offset is 0 or satisfies one or more stopping criteria, such as a stopping threshold difference. In some implementations, the control unit 114 uses a PID controller to adjust one or more timestamps. In some implementations, the control unit 114 performs feedback loops to adjust one or more sensor data streams timestamps without any manual intervention.

In some implementations, the control unit 114 or the robot 102 perform one or more processes while obtaining and processing the sensor data 110 and 112. For example, the control unit 114 or the robot 102 can perform one or more processes to simulate a realistic processing load. A processing load can affect a processing delay for the sensor data 110 and 112. By starting or ending processes, the control unit 114 or the robot 102 can adjust a current processing load to an average processing load, or another processing amount, for synchronization using the offset synchronization object 108.

In some implementations, the time offset engine 126 updates the offset 128 using an indication of one or more processes. For example, the one or more processes can increase a delay for one or more sensor data streams. The time offset engine 126 can determine an increase or decrease in one or more processes (e.g., processes performed by computer processors of the control unit 114). The time offset engine 126 can adjust a delay for one or more sensor data streams using an indication of change or no change to one or more processes (e.g., increase a delay for a process intensive sensor data stream by a certain amount using an indication that another process's bandwidth has increased).

In some implementations, the time offset engine 126 increases delays, using indications of other processes, more for process intensive sensor data streams than for process non-intensive sensor data streams. For example, the time offset engine 126 can determine if a sensor data stream is intensive or non-intensive or a level indicating an extent of intensiveness. The time offset engine 126 can then determine a delay adjustment for the particular sensor data stream using an indication of the sensor data streams processing requirements.

In some implementations, the control unit 114 obtains processing bandwidth corresponding to processing the sensor data from the robot 102. In some implementations, the sensor data 110 and 112 are processed (e.g., by the control unit 114) under two or more processing conditions to indicate how different sensor data streams are affected. For example, depending on processing load, a first data stream can be delayed by 5 milliseconds (ms) under a first load but delayed by 30 ms under a second load greater than the first load or that relies on specific components (e.g., graphics processing unit (GPU), central processing unit (CPU), among others). A second data stream can be delayed 15 ms under the first load but delayed 20 ms under the second load (e.g., delays generated by the time offset engine 126). The control unit 114 can determine, using one or more delays for particular sensors, a model for predicting a delay for a given sensor given a current bandwidth for one or more processors of the control unit 114.

In some implementations, the time offset engine 126 adjusts subsequent data streams using the offset 128. For example, the time offset engine 126 can adjust a data stream to increase or decrease a timestamp value by the offset 128. The timestamp value can be included with the set of data, e.g., as metadata. After adjusting a data stream, the time offset engine 126 can provide the corrected data stream to a subsequent process for navigation, environment interaction, any other process performed by processing components of the control unit 114, or a combination of these.

In some implementations, after determining the offset 128, the control unit 114 obtains subsequent data from the robot 102. For example, the control unit 114 can obtain third sensor data from the second sensor 106. The control unit 114 can use the offset 128 to timestamp the obtained third sensor data such that the third sensor data is correlated with other sensor data captured by other sensors of the robot 102.

In some implementations, offsets in time cause multi-layering in walls perceived by two or more sensors, such as the sensor 104 and 106. For example, if the robot 102 is rotating in front of a wall, then when the wall is visualized in a top-view, instead of a flat wall, the robot 102, and the control unit 114, can detect an RGB-D point cloud aligned at different angles. To address this issue, the system 100 adjusts timestamps such that delays in processing can be alleviated while accounting for the inability of some objects from being perceived by two or more sensors that do not share a sensing ability (e.g., ToF and RGB). This may be especially important in cases of mapping a given space using RGB-D SLAM techniques.

This adjustment can be beneficial in preventing sensor data errors, including sensing things that do not represent real aspects of an actual space. For example, without one or more of the features described in this specification, ToF can be delayed with respect to visual data (e.g., RGB camera). If the control unit 114 does not compensate for the delay, another sensor (e.g., RGB) may indicate that the robot 102 has pivoted to point upwards towards the top of a wall. If the RGB data is delayed, the sensor data from a RGB can indicate a measurement to a previous point on the wall, such as a middle point, as a measurement to a point near the top of the wall. This process can have the effect of warping the wall, as sensed by the robot 102, to a concave shape when, in reality, the wall is flat. This can have negative effects in navigation or other actions performed by a robot, e.g., cause the robot to navigate as if the wall were concave when it is flat, which might cause the robot to crash into the wall or another object.

In some implementations, the control unit 114 performs one or more operations similar to an actual use case to simulate realistic workloads during offset calculation. For example, processing bandwidth or workload can affect a delay of one or more processors. To help ensure an accurate offset calculation, the control unit 114 can perform one or more operations to simulate a realistic processing environment. For example, for navigation, the control unit 114 may obtain three types of sensor data from the robot 102. To help ensure an accurate offset for navigation, the control unit 114 can obtain the three types of sensor data from the robot 102 and process them to simulate an actual navigation processing load.

In some implementations, the robot 102 firmware, hardware, or other processing element is updated or changed. For example, programmers can update the processing steps for LIDAR sensor data. By updating the processing, a delay time between various sensors may change. In this case, the robot can obtain the sensor data to determine a new offset which may be different than previously obtained offsets due, at least, to the changes to the processing steps.

In some implementations, the control unit 114 performs offset calculation periodically to update an offset. For example, delays can change over time depending on workload of a system or age of a processing component, among other factors. In order to maintain an accurate offset for sensor data, the control unit 114 can determine that a time has passed since a last offset calculation and instruct the robot 102 to navigate to a location of the offset synchronization object 108 or generate a signal to start a rotation of the offset synchronization object 108.

In some implementations, offset calculation is performed by the control unit 114 after delivery to a user. For example, a user can purchase the robot 102. When the robot 102 arrives, the robot 102 can obtain sensor data representing an object, such as the offset synchronization object 108, as a form of initial sensor calibration before performing one or more tasks.

In some implementations, the control unit 114 calculates an offset as an initial sensor calibration in a manufacturing stage. For example, as a part of manufacturing the robot 102, the robot 102 and communicably connected control unit 114 can calculate an offset as described and compensate for any sensor delays.

The control unit 114 is an example of a system implemented as computer programs on one or more computers in one or more locations, in which the systems, components, and techniques described in this specification are implemented. The network (not shown), such as a local area network (“LAN”), wide area network (“WAN”), the Internet, or a combination thereof, can connect the robot 102 and the control unit 114. The control unit 114 may use a single server computer or multiple server computers operating in conjunction with one another, including, for example, a set of remote computers deployed as a cloud computing service.

The control unit 114 can include several different functional components, including the object detector 116, the difference engine 122, and the time offset engine 126. The object detector 116, the difference engine 122, and the time offset engine 126, or a combination of one or more of these, can include one or more data processing apparatuses, can be implemented in code, or a combination of both. For instance, each of the object detector 116, the difference engine 122, and the time offset engine 126 can include one or more data processors and instructions that cause the one or more data processors to perform the operations discussed herein.

The various functional components of the control unit 114 may be installed on one or more computers as separate functional components or as different modules of a same functional component. For example, the components, including the object detector 116, the difference engine 122, and the time offset engine 126, of the control unit 114 can be implemented as computer programs installed on one or more computers in one or more locations that are coupled to each through a network. In cloud-based systems for example, these components can be implemented by individual computing nodes of a distributed computing system.

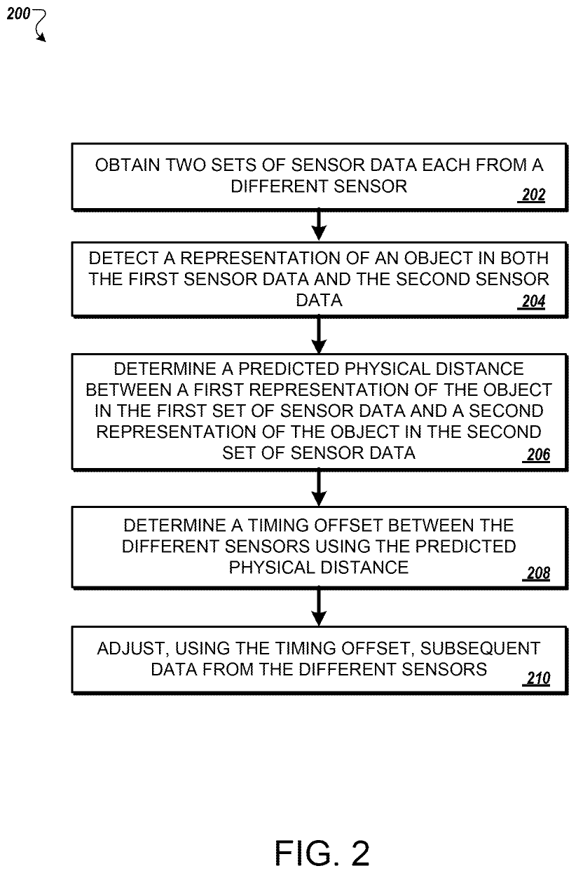

FIG. 2 is a flow diagram illustrating an example of a process 200 for sensor timing correlation. The process 200 can be performed by one or more computers, such as the control unit 114.

The process 200 includes obtaining two sets of sensor data each from a different sensor (202). For example, the as shown in FIG. 1, the sensors 104 and 106 can obtain the sensor data 110 and 112. The control unit 114 can obtain the sensor data 110 and 112.

The process 200 includes detecting a representation of an object in both the first sensor data and the second sensor data (204). For example, the object detector 116 can detect the offset synchronization object 108 in the sensor data 110 and 112.

The process 200 includes determining a predicted physical distance between a first representation of the object in the first set of sensor data and a second representation of the object in the second set of sensor data (206). For example, the difference engine 122 can determine a predicted physical difference between the representation of the offset synchronization object 108 in the sensor data 110 and the representation of the offset synchronization object 108 in the sensor data 112. In some examples, instead of or in addition to determining the predicted physical distance, the process 200 can include determining a difference between the first representation and the second representation. The difference can be the distance between the representations of the objects in the corresponding images, differences in features of the representations, other appropriate differences, or a combination of these.

The process 200 includes determining a timing offset between the different sensors using the predicted physical distance (208). For example, the time offset engine 126 can determine, using one or more values from the difference engine 122, the time offset 128. In some implementations, the process 200 can determine the timing offset using the difference between the first representation and the second representation.

The process 200 includes adjusting, using the timing offset, subsequent data from the different sensors (210). For example, the time offset engine 126 can apply the offset 128 generated by the time offset engine 126 to one or more subsequent data streams obtained from the sensors 104 and 106. Adjusted sensor data can be used to perform one or more actions, including navigation, localization, environmental adjustments (e.g., using a robotic hand to pick up or move an object in space), among others.

The order of steps in the process 200 described above is illustrative only and can be performed in different orders. For example, step 206 and step 208 can be performed concurrently by the control unit 114. The difference engine 122 can determine a difference between two or more representations of the offset synchronization object 108 and the time offset engine 126 can determine an offset using one or more values generated by the difference engine 122 to represent the difference.

In some implementations, the process 200 can include additional steps, fewer steps, or some of the steps can be divided into multiple steps. For example, the step 210 can be optional. The process 200 can include adjusting a sensor data obtaining process to automatically determine a timestamp using a generated offset (e.g., the offset 128) for a given sensor data stream without separately adjusting one or more sensor data streams.

In this specification the term “engine” refers broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

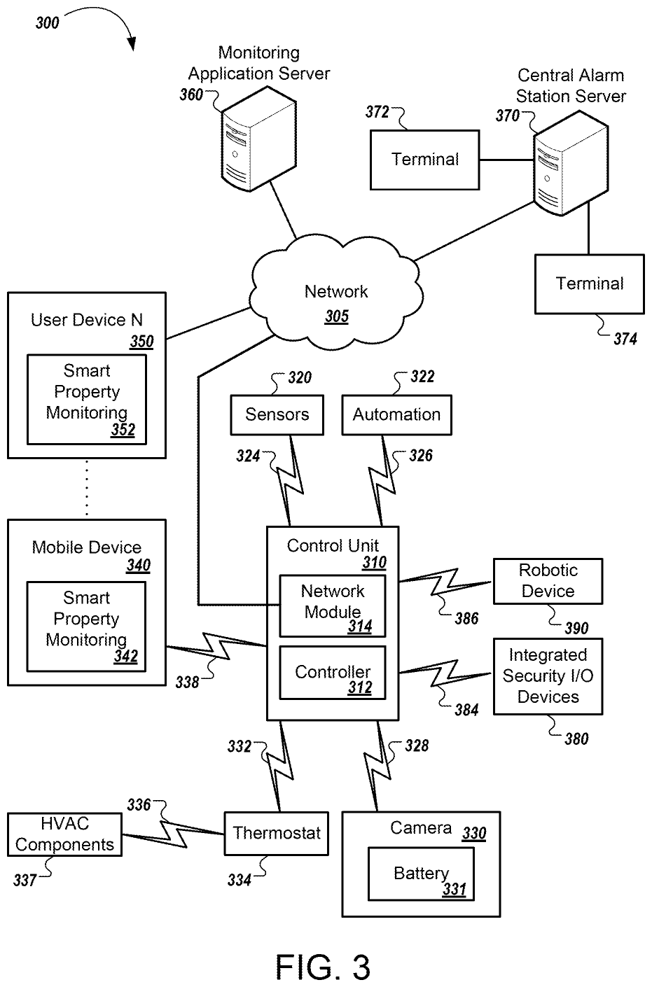

FIG. 3 is a diagram illustrating an example of a property monitoring system 300. The property monitoring system 300 includes a network 305, a control unit 310, one or more user devices 340 and 350, a monitoring application server 360, and a central alarm station server 370. In some examples, the network 305 facilitates communications between the control unit 310, the one or more user devices 340 and 350, the monitoring application server 360, and the central alarm station server 370.

The network 305 is configured to enable exchange of electronic communications between devices connected to the network 305. For example, the network 305 may be configured to enable exchange of electronic communications between the control unit 310, the one or more user devices 340 and 350, the monitoring application server 360, and the central alarm station server 370. The network 305 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 305 may include multiple networks or subnetworks, each of which may include, for example, a wired or wireless data pathway. The network 305 may include a circuit-switched network, a packet-switched data network, or any other network able to carry electronic communications (e.g., data or voice communications). For example, the network 305 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 305 may include one or more networks that include wireless data channels and wireless voice channels. The network 305 may be a wireless network, a broadband network, or a combination of networks including a wireless network and a broadband network.

The control unit 310 includes a controller 312 and a network module 314. The controller 312 is configured to control a control unit monitoring system (e.g., a control unit system) that includes the control unit 310. In some examples, the controller 312 may include a processor or other control circuitry configured to execute instructions of a program that controls operation of a control unit system. In these examples, the controller 312 may be configured to receive input from sensors, flow meters, or other devices included in the control unit system and control operations of devices included in the household (e.g., speakers, lights, doors, etc.). For example, the controller 312 may be configured to control operation of the network module 314 included in the control unit 310.

The network module 314 is a communication device configured to exchange communications over the network 305. The network module 314 may be a wireless communication module configured to exchange wireless communications over the network 305. For example, the network module 314 may be a wireless communication device configured to exchange communications over a wireless data channel and a wireless voice channel. In this example, the network module 314 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 314 also may be a wired communication module configured to exchange communications over the network 305 using a wired connection. For instance, the network module 314 may be a modem, a network interface card, or another type of network interface device. The network module 314 may be an Ethernet network card configured to enable the control unit 310 to communicate over a local area network and/or the Internet. The network module 314 also may be a voice band modem configured to enable the alarm panel to communicate over the telephone lines of Plain Old Telephone Systems (POTS).

The control unit system that includes the control unit 310 includes one or more sensors. For example, the monitoring system 300 may include multiple sensors 320. The sensors 320 may include a lock sensor, a contact sensor, a motion sensor, or any other type of sensor included in a control unit system. The sensors 320 also may include an environmental sensor, such as a temperature sensor, a water sensor, a rain sensor, a wind sensor, a light sensor, a smoke detector, a carbon monoxide detector, an air quality sensor, etc. The sensors 320 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the property. The health monitoring sensor can collect various health data, including pulse, heart-rate, respiration rate, sugar or glucose level, bodily temperature, or motion data. The sensors 320 can include a radio-frequency identification (RFID) sensor that identifies a particular article that includes a pre-assigned RFID tag.

The control unit 310 communicates with the module 322 and a camera 330 to perform monitoring. The module 322 is connected to one or more devices that enable property automation, e.g., home or business automation. For instance, the module 322 may be connected to one or more lighting systems and may be configured to control operation of the one or more lighting systems. Also, the module 322 may be connected to one or more electronic locks at the property and may be configured to control operation of the one or more electronic locks (e.g., control Z-Wave locks using wireless communications in the Z-Wave protocol). Further, the module 322 may be connected to one or more appliances at the property and may be configured to control operation of the one or more appliances. The module 322 may include multiple modules that are each specific to the type of device being controlled in an automated manner. The module 322 may control the one or more devices based on commands received from the control unit 310. For instance, the module 322 may cause a lighting system to illuminate an area to provide a better image of the area when captured by a camera 330. The camera 330 can include one or more batteries 331 that require charging.

A drone 390 can be used to survey the electronic system 300. In particular, the drone 390 can capture images of each item found in the electronic system 300 and provide images to the control unit 310 for further processing. Alternatively, the drone 390 can process the images to determine an identification of the items found in the electronic system 300.

The camera 330 may be a video/photographic camera or other type of optical sensing device configured to capture images. For instance, the camera 330 may be configured to capture images of an area within a property monitored by the control unit 310. The camera 330 may be configured to capture single, static images of the area or video images of the area in which multiple images of the area are captured at a relatively high frequency (e.g., thirty images per second) or both. The camera 330 may be controlled based on commands received from the control unit 310.

The camera 330 may be triggered by several different types of techniques. For instance, a Passive Infra-Red (PIR) motion sensor may be built into the camera 330 and used to trigger the camera 330 to capture one or more images when motion is detected. The camera 330 also may include a microwave motion sensor built into the camera and used to trigger the camera 330 to capture one or more images when motion is detected. The camera 330 may have a “normally open” or “normally closed” digital input that can trigger capture of one or more images when external sensors (e.g., the sensors 320, PIR, door/window, etc.) detect motion or other events. In some implementations, the camera 330 receives a command to capture an image when external devices detect motion or another potential alarm event. The camera 330 may receive the command from the controller 312 or directly from one of the sensors 320.

In some examples, the camera 330 triggers integrated or external illuminators (e.g., Infra-Red, Z-wave controlled “white” lights, lights controlled by the module 322, etc.) to improve image quality when the scene is dark. An integrated or separate light sensor may be used to determine if illumination is desired and may result in increased image quality.

The camera 330 may be programmed with any combination of time/day schedules, system “arming state”, or other variables to determine whether images should be captured or not when triggers occur. The camera 330 may enter a low-power mode when not capturing images. In this case, the camera 330 may wake periodically to check for inbound messages from the controller 312. The camera 330 may be powered by internal, replaceable batteries, e.g., if located remotely from the control unit 310. The camera 330 may employ a small solar cell to recharge the battery when light is available. The camera 330 may be powered by the controller's 312 power supply if the camera 330 is co-located with the controller 312.

In some implementations, the camera 330 communicates directly with the monitoring application server 360 over the Internet. In these implementations, image data captured by the camera 330 does not pass through the control unit 310 and the camera 330 receives commands related to operation from the monitoring application server 360.

The system 300 also includes thermostat 334 to perform dynamic environmental control at the property. The thermostat 334 is configured to monitor temperature and/or energy consumption of an HVAC system associated with the thermostat 334, and is further configured to provide control of environmental (e.g., temperature) settings. In some implementations, the thermostat 334 can additionally or alternatively receive data relating to activity at a property and/or environmental data at a property, e.g., at various locations indoors and outdoors at the property. The thermostat 334 can directly measure energy consumption of the HVAC system associated with the thermostat, or can estimate energy consumption of the HVAC system associated with the thermostat 334, for example, based on detected usage of one or more components of the HVAC system associated with the thermostat 334. The thermostat 334 can communicate temperature and/or energy monitoring information to or from the control unit 310 and can control the environmental (e.g., temperature) settings based on commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In addition, the control unit 310 can be a gateway device that communicates with the dynamically programmable thermostat 334. In some implementations, the thermostat 334 is controlled via one or more module 322.

A module 337 is connected to one or more components of an HVAC system associated with a property, and is configured to control operation of the one or more components of the HVAC system. In some implementations, the module 337 is also configured to monitor energy consumption of the HVAC system components, for example, by directly measuring the energy consumption of the HVAC system components or by estimating the energy usage of the one or more HVAC system components based on detecting usage of components of the HVAC system. The module 337 can communicate energy monitoring information and the state of the HVAC system components to the thermostat 334 and can control the one or more components of the HVAC system based on commands received from the thermostat 334.

In some examples, the system 300 further includes one or more robotic devices 390. The robotic devices 390 may be any type of robots that are capable of moving and taking actions that assist in security monitoring. For example, the robotic devices 390 may include drones that are capable of moving throughout a property based on automated control technology and/or user input control provided by a user. In this example, the drones may be able to fly, roll, walk, or otherwise move about the property. The drones may include helicopter type devices (e.g., quad copters), rolling helicopter type devices (e.g., roller copter devices that can fly and also roll along the ground, walls, or ceiling) and land vehicle type devices (e.g., automated cars that drive around a property). In some cases, the robotic devices 390 may be robotic devices 390 that are intended for other purposes and merely associated with the system 300 for use in appropriate circumstances. For instance, a robotic vacuum cleaner device may be associated with the monitoring system 300 as one of the robotic devices 390 and may be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 may navigate within the property using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 390 may include control processors that process output from the various sensors and control the robotic devices 390 to move along a path that reaches the desired destination and avoids obstacles. In this regard, the control processors detect walls or other obstacles in the property and guide movement of the robotic devices 390 in a manner that avoids the walls and other obstacles.

In addition, the robotic devices 390 may store data that describes attributes of the property. For instance, the robotic devices 390 may store a floorplan and/or a three-dimensional model of the property that enables the robotic devices 390 to navigate the property. During initial configuration, the robotic devices 390 may receive the data describing attributes of the property, determine a frame of reference to the data (e.g., a property or reference location in the property), and navigate the property based on the frame of reference and the data describing attributes of the property. Further, initial configuration of the robotic devices 390 also may include learning of one or more navigation patterns in which a user provides input to control the robotic devices 390 to perform a specific navigation action (e.g., fly to an upstairs bedroom and spin around while capturing video and then return to a property charging base). In this regard, the robotic devices 390 may learn and store the navigation patterns such that the robotic devices 390 may automatically repeat the specific navigation actions upon a later request.

In some examples, the robotic devices 390 may include data capture and recording devices. In these examples, the robotic devices 390 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the property and users in the property. The one or more biometric data collection tools may be configured to collect biometric samples of a person in the property with or without contact of the person. For instance, the biometric data collection tools may include a fingerprint scanner, a hair sample collection tool, a skin cell collection tool, and/or any other tool that allows the robotic devices 390 to take and store a biometric sample that can be used to identify the person (e.g., a biometric sample with DNA that can be used for DNA testing).

In some implementations, the robotic devices 390 may include output devices. In these implementations, the robotic devices 390 may include one or more displays, one or more speakers, and/or any type of output devices that allow the robotic devices 390 to communicate information to a nearby user.

The robotic devices 390 also may include a communication module that enables the robotic devices 390 to communicate with the control unit 310, each other, and/or other devices. The communication module may be a wireless communication module that allows the robotic devices 390 to communicate wirelessly. For instance, the communication module may be a Wi-Fi module that enables the robotic devices 390 to communicate over a local wireless network at the property. The communication module further may be a 900 MHz wireless communication module that enables the robotic devices 390 to communicate directly with the control unit 310. Other types of short-range wireless communication protocols, such as Bluetooth, Bluetooth LE, Z-wave, Zigbee, etc., may be used to allow the robotic devices 390 to communicate with other devices in the property. In some implementations, the robotic devices 390 may communicate with each other or with other devices of the system 300 through the network 305.

The robotic devices 390 further may include processor and storage capabilities. The robotic devices 390 may include any suitable processing devices that enable the robotic devices 390 to operate applications and perform the actions described throughout this disclosure. In addition, the robotic devices 390 may include solid-state electronic storage that enables the robotic devices 390 to store applications, configuration data, collected sensor data, and/or any other type of information available to the robotic devices 390.

The robotic devices 390 are associated with one or more charging stations. The charging stations may be located at predefined home base or reference locations in the property. The robotic devices 390 may be configured to navigate to the charging stations after completion of tasks needed to be performed for the property monitoring system 300. For instance, after completion of a monitoring operation or upon instruction by the control unit 310, the robotic devices 390 may be configured to automatically fly to and land on one of the charging stations. In this regard, the robotic devices 390 may automatically maintain a fully charged battery in a state in which the robotic devices 390 are ready for use by the property monitoring system 300.

The charging stations may be contact based charging stations and/or wireless charging stations. For contact-based charging stations, the robotic devices 390 may have readily accessible points of contact that the robotic devices 390 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 390 may charge through a wireless exchange of power. In these cases, the robotic devices 390 need only locate themselves closely enough to the wireless charging stations for the wireless exchange of power to occur. In this regard, the positioning needed to land at a predefined home base or reference location in the property may be less precise than with a contact-based charging station. Based on the robotic devices 390 landing at a wireless charging station, the wireless charging station outputs a wireless signal that the robotic devices 390 receive and convert to a power signal that charges a battery maintained on the robotic devices 390.

In some implementations, each of the robotic devices 390 has a corresponding and assigned charging station such that the number of robotic devices 390 equals the number of charging stations. In these implementations, the robotic devices 390 always navigate to the specific charging station assigned to that robotic device. For instance, a first robotic device may always use a first charging station and a second robotic device may always use a second charging station.

In some examples, the robotic devices 390 may share charging stations. For instance, the robotic devices 390 may use one or more community charging stations that are capable of charging multiple robotic devices 390. The community charging station may be configured to charge multiple robotic devices 390 in parallel. The community charging station may be configured to charge multiple robotic devices 390 in serial such that the multiple robotic devices 390 take turns charging and, when fully charged, return to a predefined home base or reference location in the property that is not associated with a charger. The number of community charging stations may be less than the number of robotic devices 390.

Also, the charging stations may not be assigned to specific robotic devices 390 and may be capable of charging any of the robotic devices 390. In this regard, the robotic devices 390 may use any suitable, unoccupied charging station when not in use. For instance, when one of the robotic devices 390 has completed an operation or is in need of battery charge, the control unit 310 references a stored table of the occupancy status of each charging station and instructs the robotic device to navigate to the nearest charging station that is unoccupied.

The system 300 further includes one or more integrated security devices 380. The one or more integrated security devices may include any type of device used to provide alerts based on received sensor data. For instance, the one or more control units 310 may provide one or more alerts to the one or more integrated security input/output devices 380. Additionally, the one or more control units 310 may receive sensor data from the sensors 320 and determine whether to provide an alert to the one or more integrated security input/output devices 380.

The sensors 320, the module 322, the camera 330, the thermostat 334, and the integrated security devices 380 may communicate with the controller 312 over communication links 324, 326, 328, 332, 338, 384, and 386. The communication links 324, 326, 328, 332, 338, 384, and 386 may be a wired or wireless data pathway configured to transmit signals from the sensors 320, the module 322, the camera 330, the thermostat 334, the drone 390, and the integrated security devices 380 to the controller 312. The sensors 320, the module 322, the camera 330, the thermostat 334, the drone 390, and the integrated security devices 380 may continuously transmit sensed values to the controller 312, periodically transmit sensed values to the controller 312, or transmit sensed values to the controller 312 in response to a change in a sensed value. In some implementations, the drone 390 can communicate with the monitoring application server 360 over network 305. The drone 390 can connect and communicate with the monitoring application server 360 using a Wi-Fi or a cellular connection.

The communication links 324, 326, 328, 332, 338, 384, and 386 may include a local network. The sensors 320, the module 322, the camera 330, the thermostat 334, the drone 390 and the integrated security devices 380, and the controller 312 may exchange data and commands over the local network. The local network may include 802.11 “Wi-Fi” wireless Ethernet (e.g., using low-power Wi-Fi chipsets), Z-Wave, Zigbee, Bluetooth, “HomePlug” or other “Powerline” networks that operate over AC wiring, and a Category 5 (CAT5) or Category 6 (CAT6) wired Ethernet network. The local network may be a mesh network constructed based on the devices connected to the mesh network.

The monitoring application server 360 is an electronic device configured to provide monitoring services by exchanging electronic communications with the control unit 310, the one or more user devices 340 and 350, and the central alarm station server 370 over the network 305. For example, the monitoring application server 360 may be configured to monitor events (e.g., alarm events) generated by the control unit 310. In this example, the monitoring application server 360 may exchange electronic communications with the network module 314 included in the control unit 310 to receive information regarding events (e.g., alerts) detected by the control unit 310. The monitoring application server 360 also may receive information regarding events (e.g., alerts) from the one or more user devices 340 and 350.

In some examples, the monitoring application server 360 may route alert data received from the network module 314 or the one or more user devices 340 and 350 to the central alarm station server 370. For example, the monitoring application server 360 may transmit the alert data to the central alarm station server 370 over the network 305.

The monitoring application server 360 may store sensor and image data received from the monitoring system 300 and perform analysis of sensor and image data received from the monitoring system 300. Based on the analysis, the monitoring application server 360 may communicate with and control aspects of the control unit 310 or the one or more user devices 340 and 350.

The monitoring application server 360 may provide various monitoring services to the system 300. For example, the monitoring application server 360 may analyze the sensor, image, and other data to determine an activity pattern of a resident of the property monitored by the system 300. In some implementations, the monitoring application server 360 may analyze the data for alarm conditions or may determine and perform actions at the property by issuing commands to one or more components of the system 300, possibly through the control unit 310.

The central alarm station server 370 is an electronic device configured to provide alarm monitoring service by exchanging communications with the control unit 310, the one or more mobile devices 340 and 350, and the monitoring application server 360 over the network 305. For example, the central alarm station server 370 may be configured to monitor alerting events generated by the control unit 310. In this example, the central alarm station server 370 may exchange communications with the network module 314 included in the control unit 310 to receive information regarding alerting events detected by the control unit 310. The central alarm station server 370 also may receive information regarding alerting events from the one or more mobile devices 340 and 350 and/or the monitoring application server 360.

The central alarm station server 370 is connected to multiple terminals 372 and 374. The terminals 372 and 374 may be used by operators to process alerting events. For example, the central alarm station server 370 may route alerting data to the terminals 372 and 374 to enable an operator to process the alerting data. The terminals 372 and 374 may include general-purpose computers (e.g., desktop personal computers, workstations, or laptop computers) that are configured to receive alerting data from a server in the central alarm station server 370 and render a display of information based on the alerting data. For instance, the controller 312 may control the network module 314 to transmit, to the central alarm station server 370, alerting data indicating that a sensor 320 detected motion from a motion sensor via the sensors 320. The central alarm station server 370 may receive the alerting data and route the alerting data to the terminal 372 for processing by an operator associated with the terminal 372. The terminal 372 may render a display to the operator that includes information associated with the alerting event (e.g., the lock sensor data, the motion sensor data, the contact sensor data, etc.) and the operator may handle the alerting event based on the displayed information.

In some implementations, the terminals 372 and 374 may be mobile devices or devices designed for a specific function. Although FIG. 3 illustrates two terminals for brevity, actual implementations may include more (and, perhaps, many more) terminals.

The one or more user devices 340 and 350 are devices that host and display user interfaces. For instance, the user device 340 is a mobile device that hosts or runs one or more native applications (e.g., the smart property application 342). The user device 340 may be a cellular phone or a non-cellular locally networked device with a display. The user device 340 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 340 may perform functions unrelated to the monitoring system, such as placing personal telephone calls, playing music, playing video, displaying pictures, browsing the Internet, maintaining an electronic calendar, etc.

The user device 340 includes a smart property application 342. The smart property application 342 refers to a software/firmware program running on the corresponding mobile device that enables the user interface and features described throughout. The user device 340 may load or install the smart property application 342 based on data received over a network or data received from local media. The smart property application 342 runs on mobile devices platforms, such as iPhone, iPod touch, Blackberry, Google Android, Windows Mobile, etc. The smart property application 342 enables the user device 340 to receive and process image and sensor data from the monitoring system.

The user device 350 may be a general-purpose computer (e.g., a desktop personal computer, a workstation, or a laptop computer) that is configured to communicate with the monitoring application server 360 and/or the control unit 310 over the network 305. The user device 350 may be configured to display a smart property user interface 352 that is generated by the user device 350 or generated by the monitoring application server 360. For example, the user device 350 may be configured to display a user interface (e.g., a web page) provided by the monitoring application server 360 that enables a user to perceive images captured by the camera 330 and/or reports related to the monitoring system. Although FIG. 3 illustrates two user devices for brevity, actual implementations may include more (and, perhaps, many more) or fewer user devices.

In some implementations, the one or more user devices 340 and 350 communicate with and receive monitoring system data from the control unit 310 using the communication link 338. For instance, the one or more user devices 340 and 350 may communicate with the control unit 310 using various local wireless protocols such as Wi-Fi, Bluetooth, Z-wave, Zigbee, HomePlug (Ethernet over power line), or wired protocols such as Ethernet and USB, to connect the one or more user devices 340 and 350 to local security and automation equipment. The one or more user devices 340 and 350 may connect locally to the monitoring system and its sensors and other devices. The local connection may improve the speed of status and control communications because communicating through the network 305 with a remote server (e.g., the monitoring application server 360) may be significantly slower.

Although the one or more user devices 340 and 350 are shown as communicating with the control unit 310, the one or more user devices 340 and 350 may communicate directly with the sensors and other devices controlled by the control unit 310. In some implementations, the one or more user devices 340 and 350 replace the control unit 310 and perform the functions of the control unit 310 for local monitoring and long range/offsite communication.

In other implementations, the one or more user devices 340 and 350 receive monitoring system data captured by the control unit 310 through the network 305. The one or more user devices 340, 350 may receive the data from the control unit 310 through the network 305 or the monitoring application server 360 may relay data received from the control unit 310 to the one or more user devices 340 and 350 through the network 305. In this regard, the monitoring application server 360 may facilitate communication between the one or more user devices 340 and 350 and the monitoring system.

In some implementations, the one or more user devices 340 and 350 may be configured to switch whether the one or more user devices 340 and 350 communicate with the control unit 310 directly (e.g., through link 338) or through the monitoring application server 360 (e.g., through network 305) based on a location of the one or more user devices 340 and 350. For instance, when the one or more user devices 340 and 350 are located close to the control unit 310 and in range to communicate directly with the control unit 310, the one or more user devices 340 and 350 use direct communication. When the one or more user devices 340 and 350 are located far from the control unit 310 and not in range to communicate directly with the control unit 310, the one or more user devices 340 and 350 use communication through the monitoring application server 360.

Although the one or more user devices 340 and 350 are shown as being connected to the network 305, in some implementations, the one or more user devices 340 and 350 are not connected to the network 305. In these implementations, the one or more user devices 340 and 350 communicate directly with one or more of the monitoring system components and no network (e.g., Internet) connection or reliance on remote servers is needed.

In some implementations, the one or more user devices 340 and 350 are used in conjunction with only local sensors and/or local devices in a house. In these implementations, the system 300 includes the one or more user devices 340 and 350, the sensors 320, the module 322, the camera 330, and the robotic devices, e.g., that can include the drone 390. The one or more user devices 340 and 350 receive data directly from the sensors 320, the module 322, the camera 330, and the robotic devices and send data directly to the sensors 320, the module 322, the camera 330, and the robotic devices. The one or more user devices 340, 350 provide the appropriate interfaces/processing to provide visual surveillance and reporting.

In other implementations, the system 300 further includes network 305 and the sensors 320, the module 322, the camera 330, the thermostat 334, and the robotic devices are configured to communicate sensor and image data to the one or more user devices 340 and 350 over network 305 (e.g., the Internet, cellular network, etc.). In yet another implementation, the sensors 320, the module 322, the camera 330, the thermostat 334, and the robotic devices are intelligent enough to change the communication pathway from a direct local pathway when the one or more user devices 340 and 350 are in close physical proximity to the sensors 320, the module 322, the camera 330, the thermostat 334, and the robotic devices to a pathway over network 305 when the one or more user devices 340 and 350 are farther from the sensors 320, the module 322, the camera 330, the thermostat 334, and the robotic devices. In some examples, the system leverages GPS information from the one or more user devices 340 and 350 to determine whether the one or more user devices 340 and 350 are close enough to the sensors 320, the module 322, the camera 330, the thermostat 334, and the robotic devices to use the direct local pathway or whether the one or more user devices 340 and 350 are far enough from the sensors 320, the module 322, the camera 330, the thermostat 334, and the robotic devices that the pathway over network 305 is required. In other examples, the system leverages status communications (e.g., pinging) between the one or more user devices 340 and 350 and the sensors 320, the module 322, the camera 330, the thermostat 334, and the robotic devices to determine whether communication using the direct local pathway is possible. If communication using the direct local pathway is possible, the one or more user devices 340 and 350 communicate with the sensors 320, the module 322, the camera 330, the thermostat 334, and the robotic devices using the direct local pathway. If communication using the direct local pathway is not possible, the one or more user devices 340 and 350 communicate with the sensors 320, the module 322, the camera 330, the thermostat 334, and the robotic devices using the pathway over network 305.

In some implementations, the system 300 provides end users with access to images captured by the camera 330 to aid in decision-making. The system 300 may transmit the images captured by the camera 330 over a wireless WAN network to the user devices 340 and 350. Because transmission over a wireless WAN network may be relatively expensive, the system 300 can use several techniques to reduce costs while providing access to significant levels of useful visual information (e.g., compressing data, down-sampling data, sending data only over inexpensive LAN connections, or other techniques).

In some implementations, a state of the monitoring system 300 and other events sensed by the monitoring system 300 may be used to enable/disable video/image recording devices (e.g., the camera 330). In these implementations, the camera 330 may be set to capture images on a periodic basis when the alarm system is armed in an “away” state, but set not to capture images when the alarm system is armed in a “stay” state or disarmed. In addition, the camera 330 may be triggered to begin capturing images when the alarm system detects an event, such as an alarm event, a door-opening event for a door that leads to an area within a field of view of the camera 330, or motion in the area within the field of view of the camera 330. In other implementations, the camera 330 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A system comprising one or more computers and one or more storage devices on which are stored instructions that are operable, when executed by the one or more computers, to cause the one or more computers to perform operations comprising:
obtaining (i) first sensor data from a first sensor and (ii) second sensor data from a second sensor;
detecting a representation of an object in both the first sensor data and the second sensor data;
determining a predicted physical distance between a first representation of the object in the first sensor data and a second representation of the object in the second sensor data;
determining a timing offset between the different sensors using the predicted physical distance between the first representation of the object and the second representation of the object; and
adjusting, using the timing offset, subsequent data from the first sensor or the second sensor.

2. The system of claim 1, wherein detecting the representation of the object in both the first sensor data and the second sensor data comprises:
detecting a rotating object with at least one first feature detectable by the first sensor and at least one second feature detectable by the second sensor.

3. The system of claim 2, wherein:
the first sensor is an infrared camera and the at least one first feature comprises an infrared marker; and
the second sensor is a depth sensor that captures depth data of the rotation of the object.

4. The system of claim 2, wherein determining the distance between the first representation of the object in the first sensor data and the second representation of the object in the second sensor data comprises:
determining an angular distance between (i) a first line indicating a position of the object in the first sensor data and (ii) a second line indicating a position of the object in the second sensor data.

5. The system of claim 1, prior to determining the timing offset between the different sensors using the distance between the first representation of the object and the second representation of the object, wherein the operations comprise:
determining a velocity of the object using the first sensor data and the second sensor data; and
subsequent to determining the velocity, determining the timing offset using the velocity.

6. The system of claim 1, comprising using the subsequent data from the first sensor or the second sensor to perform one or more of the following: navigation, localization, or environmental adjustments.

7. The system of claim 1, wherein determining the timing offset comprises:
providing the distance between the first representation of the object in the first sensor data and the second representation of the object in the second sensor data to a proportional-integral-derivative (PID) controller configured to generate output for use adjusting the subsequent data using the timing offset.

8. The system of claim 7, wherein the operations comprise:
determining that the predicted physical distance between the first representation of the object and the second representation of the object satisfies a difference threshold; and
in response to determining that the predicted physical distance satisfies the difference threshold, adjusting, using the PID controller and the timing offset, timestamps of the subsequent data from the first sensor or the second sensor to reduce, compared to a first error for the predicted physical distance, a second error for a distance between representations of a second object in the subsequent data.

9. The system of claim 1, wherein the operations comprise:
performing processing operations that simulate a processing load, wherein the processing affects processing of the first sensor data or the second sensor data.

10. The system of claim 1, wherein the operations comprise:
detecting, from a plurality of processes that the system can perform and that can cause a first change for processing data from the first sensor or a second change for processing data from the second sensor, a process performed by the system at least partially concurrently with processing of the subsequent data from the first sensor or the second sensor and that will cause the first change for processing data from the first sensor to be a different change than the second change for processing data from the second sensor; and
adjusting the timing offset used to adjust the subsequent data using a difference between the first change and the second change.

11. The system of claim 10, wherein one of the first change or the second change for processing data indicates no change.

12. The system of claim 1, wherein the operations comprise:
providing current processing bandwidth to a model configured to determine a timing offset using the current processing bandwidth; and
determining the timing offset using output from the model.

13. The system of claim 1, wherein the operations comprise:
in response to determining a change in processing firmware or hardware, obtaining (i) the first sensor data from the first sensor and (ii) the second sensor data from the second sensor.

14. One or more computer storage media encoded with instructions that, when executed by one or more computers, cause the one or more computers to perform operations comprising:
obtaining (i) first sensor data from a first sensor and (ii) second sensor data from a second sensor;
detecting a representation of an object in both the first sensor data and the second sensor data;
determining a predicted physical distance between a first representation of the object in the first sensor data and a second representation of the object in the second sensor data;
determining a timing offset between the different sensors using the predicted physical distance between the first representation of the object and the second representation of the object; and
adjusting, using the timing offset, subsequent data from the first sensor or the second sensor.

15. The system of claim 14, wherein detecting the representation of the object in both the first sensor data and the second sensor data comprises:
detecting a rotating object with at least one first feature detectable by the first sensor and at least one second feature detectable by the second sensor.

16. The system of claim 15, wherein:
the first sensor is an infrared camera and the at least one first feature comprises an infrared marker; and
the second sensor is a depth sensor that captures depth data of the rotation of the object.

17. The system of claim 15, wherein determining the distance between the first representation of the object in the first sensor data and the second representation of the object in the second sensor data comprises:
determining an angular distance between (i) a first line indicating a position of the object in the first sensor data and (ii) a second line indicating a position of the object in the second sensor data.

18. The system of claim 14, prior to determining the timing offset between the different sensors using the distance between the first representation of the object and the second representation of the object, wherein the operations comprise:
determining a velocity of the object using the first sensor data and the second sensor data; and
subsequent to determining the velocity, determining the timing offset using the velocity.

19. The system of claim 14, comprising using the subsequent data from the first sensor or the second sensor to perform one or more of the following: navigation, localization, or environmental adjustments.

20. A computer-implemented method comprising:
obtaining (i) first sensor data from a first sensor and (ii) second sensor data from a second sensor;
detecting a representation of an object in both the first sensor data and the second sensor data;
determining a predicted physical distance between a first representation of the object in the first sensor data and a second representation of the object in the second sensor data;
determining a timing offset between the different sensors using the predicted physical distance between the first representation of the object and the second representation of the object; and
adjusting, using the timing offset, subsequent data from the first sensor or the second sensor.
